(19) United States
(12) Patent Application Publication
(10) Pub. No.: US 2009/0222384 A1
(43) Pub. Date: Sep. 3, 2009

(54) APPARATUS AND METHOD FOR INTERVENTION IN ELECTRONIC MARKETS

(75) Inventor: Nicholas David Wingham Rowan, London (GB)

Correspondence Address: BROOKS KUSHMAN P.C., 1000 TOWN CENTER, TWENTY-SECOND FLOOR, SOUTHFIELD, MI, 48075, US

(73) Assignee: GUARANTEED MARKETS LTD, London (GB)

(21) Appl. No.: 12/299,718

(22) PCT Filed: Apr. 13, 2007
(86) PCT No.: PCT/GB07/01381

§ 371 Date: Nov. 5, 2008

(30) Foreign Application Priority Data
May 6, 2006 (GB) 0609037.7

(51) Int. Cl. G06Q 30/00; G06N 5/02

(52) U.S. Cl. 705/80; 706/52

(57) ABSTRACT

A transaction management system for managing the purchase of products or services by a buyer comprising: a data store for storing a seller identifier and seller offer data indicating at least one product or service offered for sale; and transaction data for each of a plurality of historical transactions, a transaction identifier, and the seller and a buyer identifier. The system also having a program store storing instructions and a processor coupled to the data store and to the program store for implementing the instructions for controlling the processor to implement a buyer interface to receive a purchase inquiry, output seller offer data for a plurality of sellers, the sellers each being able to meet the purchase criteria; and receive a purchase request accepting an offer. The processor can also analyze the transaction data to determine stability a market.

### FIELD OF THE INVENTION

The present invention relates to electronic markets, particularly those in which there are a plurality of sellers.

### BACKGROUND OF THE INVENTION

It is known that a number of distinct mechanisms exist to enable transactions between buyers and multiple sellers in an online marketplace. Each mechanism is good for particular types of trade. Examples of said mechanisms include (a) online auctions which are widely used for the offering of goods supplied by various sellers, for example www.eBay.com (b) bulletin boards in which the seller posts a message of their goods or services to be offered and awaits contact from buyers, for example www.craigslist.com (c) Request for Quote services in which a potential buyer displays details of a need and waits for potential sellers to respond, for example www.guru.com (d) online stock trading services, sometimes using a Continuous Double Auction mechanism to establish optimum price between seller and buyer, for example the service offered at www.island.com.

None of these widely available mechanisms is particularly suited to transactions involving the short term hire of a person or item, especially if the transaction is required at short notice. Examples of such transactions may include (a) a parent wishing to hire a babysitter from their local community for 2 hours this evening (b) a holidaymaker wanting to hire a surfboard this afternoon from any local resident with a board they were not using (c) a restaurant needing an extra catering assistant to cover today's 90 minute lunchtime rush.

For such transactions, existing mechanisms such as those listed earlier are either: (a) too uncertain for the buyer because they require posting a need then waiting for response from sellers who may then be unreliable (b) too troublesome for the seller because they require her to negotiate details of the transaction with any interested buyers (c) too time consuming for both parties because they require the perusal of listings, evaluation of the seller's availability for the buyer's time of need and evaluation of the seller's contactability; for example will they respond to messages in time to meet the buyer's need? Because of these factors, transactions of the type listed above tend to happen offline when they happen at all. Because such transactions carry disproportionate overheads and risk of transaction failure, many irregularly available resources dispersed among multiple owners are not traded. This is despite a potential demand from buyers and a desire to realize the value of their assets on behalf of sellers.

To overcome this gap in the art, the present inventor has previously disclosed details of a mechanism specifically for the hire of resources, available from a plurality of sellers, for very precise periods. Said mechanism for an online market can be characterized by features that may include: (a) sellers categorizing their offering from a list of market sectors (b) sellers inputting a geographic area in which their offering can be made available, typically this may be by selecting a postalcode where the person or item is based and then a radius of travel from that point, up to a possible maximum travel distance for that market sector; for some offerings, including by way of example remote work, the geographic area may be infinite (c) sellers listing the hours, or part thereof, when their offering is available for hire on any given day (d) sellers listing the times when they undertake to be contactable on behalf of buyers (e) sellers listing the terms on which their offering is to be available for purchase, this may be a flat rate per hour or a more complex formula that compensates the seller for travel distance, short notice bookings, short length bookings and other sale parameters.

These inputs allow immediate purchasing of irregularly available resources from an infinite number of sellers. A potential buyer inputs his requirements for market sector, geography and time. For example: “I need to hire a carpet cleaning device at my home address in an hour's time”. The present mechanism allows that need to be easily met by either established companies or individuals with a carpet cleaner they do not require at the present time.

On entering his requirements said buyer can immediately be shown sellers who meet the following conditions: (a) currently offering in the Carpet Cleaning Devices sector (b) have indicated availability at the time specified (c) have a contactability record that shows they are accessible to messages in the interval between the present time and the time the device is required (d) are within a pre-determined radius of the buyer's zipcode and willing for the device to be transported to said zipcode. Additionally a price may be displayed based on the seller's terms for each resource offered. Once the purchaser has selected the device, or devices, he wishes to hire, verification, insurance and payment transfer means may be offered. The marketplace can be funded by a mark-up on each transaction that is retained by market operators as payment is then transferred from buyer to seller.

Additionally the mechanism may include: (a) a record of reliability for sellers and/or buyers, this could simply be a ranking of number of past transactions including a percentage which did not result in payment transfer suggesting the transaction failed because of unreliability by one of the parties (b) output of aggregated data on patterns of demand, supply and pricing for each sector and each locality, this enables buyers to purchase when demand is low and sellers to align their times of offering with peaks in demand (c) a system allowing individual buyers to rank individual sellers with whom they have transacted, said sellers can then be prioritized for future purchases.

A market of the type outlined began operating in London, UK in December 2005. It is known as the Slivers-of-Time marketplace and trades small periods when individuals are willing to work for local employers.

Said marketplaces can transact any irregular commodity where there is an underlying unit of sale. The time of a resource, measured in hours, minutes or seconds, is the most likely focus. Other resources may be offered based on other units. Examples include: (a) a market for cake making where the unit is pounds or kilograms of the final cake (b) a market for passenger or cargo journeys where the unit is the mile, or part thereof (c) a market in overnight accommodation where a night's stay is the underlying unit that is listed and purchased. It is readily apparent the invention can be applied to commodities offered in a variety of units. For simplicity, this document will refer to the markets just characterized as “GEMs markets”.

The Problem of Instability in GEMs Markets

A particular problem with the present type of online market is a potential mismatch between buyers' needs and sellers' offerings. Each transaction has multiple parameters, all of which must align. Thus, a need for hire of a security guard can only be met if the market includes sellers offering their services: (a) within the geography required (b) at the times required (c) with seller contactable in the time required.

This mismatching is less of a problem in other mechanisms for online markets. A buyer at an auction site might typically wish to purchase a book. However, it is unlikely their need is limited by: (a) geography, a chosen book will be shipped from anywhere in the country (b) precise time slot, it will typically take a number of days for the item to arrive (c) a need for immediate contact with the seller to confirm the transaction is acceptable, typically an auction or bulletin board listing will be checked only periodically by item sellers.

Thus, a GEMs market may contain many sellers who are qualified security guards and many buyers wishing to purchase the time of security guards for precise periods. But, because the transactions are potentially so immediate, and so precise in their requirements the supply and demand may fail to align. Again, this is a greater problem for GEMs markets. A seller on an auction site may fail to sell their item but can simply re-offer it with minimal inconvenience. In a GEMs market, the commodity on offer is availability of a resource, for example a person's willingness to work at certain times today, that is input in advance. This requires that the seller: (a) inputs the periods of availability (b) remains available until purchased, or removes their availability promptly if they take on a commitment outside the present market. This is a considerably higher level of commitment to the marketplace than is required to simply list an item on a bulletin board or auction website.

Additionally, GEMs markets are less easy to launch with aggregated supply or aggregated demand. A company launching an online marketplace for standardised physical commodities will typically ensure a source of supply that immediately brings a substantial range of offerings to buyers. For instance, a relationship with a book wholesaler used to launch an Internet marketplace for books. Because GEMs markets typically rely on localised supply, which is therefore fragmented by source, there is often no comparable way of ensuring one half of a new marketplace, the commodity to be sold, is in place before the other side, buyers of that commodity, is enrolled.

Thus, it should be clear: GEMs marketplaces (a) are more prone to imbalance between buyers' needs and sellers' offerings than other mechanisms (b) require an ongoing commitment from sellers likely to be quickly threatened if sellers are repeatedly listing availability that is not purchased (c) are limited in their ability to harness already aggregated sources of supply into the market. Together these factors create a danger of instability in the market which sees sellers loosing faith and no longer bothering to input their availability. This instability is most likely when a market in a particular sector or geography is recently launched. Insufficient buyers in a fledgling market leave sellers with no incentive to continue inputting availability, which means buyers have no reason to input their purchase requests and market activity begins a spiral of decline even though external demand and supply may be strong.

The problems of this instability are most visible when a market is newly launched. The logical reaction of individual buyers and sellers is to postpone their personal involvement in the new market until a significant volume of transactions has been established. This can lead to paralysis: all users waiting for other users to enter the market in its unstable phase. Because of the high degree of commitment required from sellers this can be an impenetrable barrier to market launch.

It should be clear there is a threshold of stability above which there is sufficient market activity in any sector and geography such that: (a) there is a broad enough range of seller offerings to make it likely a buyer will have his needs met (b) occasional periods without a purchase will not endanger a seller's opinion of the market's value because it has been useful in the past and should become so again in the future. A stable market can become profitable for its operators and genuinely useful for its users. There therefore exists a need for a technical method of boosting stability in GEMs markets.

The means of achieving this must be: (a) cost effective, the transaction value in GEMs markets is likely to be small and operators will not profit from blunt intervention (b) precise, a market sector can be stable in one geography while an adjoining geography is unstable; likewise, within one area of a city a given market sector may be stable and growing while another sector is mismatched and declining (c) able to learn from trial and error, some market sectors will not have sufficient volume to ever reach stability and this must be recognised promptly (d) rewarding human intervention that accurately predicts forthcoming stability fluctuations; no technical system can predict upcoming events which may cause a market to suddenly become unstable.

### RELATED APPLICATIONS

The following applications cover enhancements to GEMs markets as described PCT/IB02/01475 discloses a means of enhancing said markets by underwriting commitments by preferred sellers. PCT/GB2004/004756 covers a means of allowing and encouraging intermediaries to promote and interact through said markets. PCT/GB2004/005126 explains additional technology to resolve problem transactions in such markets. PCT/GB2005/000178 reveals a means to enhance Slivers of Time markets by enabling targeted investment in seller development. PCT/GB05/001148 discloses an apparatus allowing sellers in such a market to input availability to sell conditional on multiple personalised factors. PCT/GB2005/001917 outlines technology for building chains of personalised transactions across a plurality of underlying sectors in said markets.

### PRIOR ART

The present inventor has disclosed details of one embodiment of an underlying market for the present invention in publications. These include two books: “Guaranteed Electronic Markets” published by Demos (London, UK) in 1997 and “Net Benefit”, published by Macmillan Palgrave in 1999.

Means of encouraging take up of particular services so they can quickly become viable are discussed in books such as The Tipping Point by Malcolm Gladwell (Little Brown, 2000). Methods of driving new membership of schemes such as pyramid selling and network marketing are known. Promotional schemes whereby existing recruits into a service are rewarded for recruiting further users are also known.

The specific problems of reaching equilibrium in a market requiring evenly matched buyers and sellers is documented in papers such as Platform Competition in Two Sided Markets, Rochet and Tirole, Nov. 26, 2001. This is often achieved by allowing one side of the market free use of a service to attract early usage. It is known for example that Diners Club card payments were processed free for restaurants for a period after launch to ensure take up that would attract individuals into becoming cardholders. Similarly, the online market for travel products, priceline.com chartered planes in its launch phase and sold the seats at cost or below to attract buyers into the new service. Refinements of these principles include US2005256800 which discloses a system of analyzing offers for particular goods or services by buyers followed by allocation of an appropriate offering. JP2005222328 outlines a system for expanding a market by matching a putative buyer with sellers and beginning the process of negotiation about a sale. WO0152091 discloses a means of constructing optimal transactions from mismatched items offered for sale. U.S. Pat. No. 6,012,045 details a means of attracting new users into online auction markets with a system to teach such users how said service works.

Technology for analysis of need in a market or supply chain is also known in the art. WO0229685 outlines a system that resolves over or under capacity with automated buying or selling of inventory. US2003167198 reveals a process that enables markets to be scanned for new product opportunities, qualifies target customers and stimulates the generation of leads. WO2004046978 discloses a means of compiling statistical reports on transactions conducted within an electronic marketplace. US2004230512 details a means of creating opportunistic auctions when resources in the financial markets remain unsold.

None of the art recognises the unique issues of GEMs markets, or their unique characteristics that enable resolution of problems around market instability.

### SUMMARY OF THE INVENTION

According to the present invention, there is provided a transaction management system for managing the purchase of products and/or services by a buyer from sellers, the system comprising: a data store for storing: seller data comprising, for each of a plurality of sellers, a seller identifier and seller offer data indicating at least one product and/or service offered for sale; and transaction data comprising, for each of a plurality of historical transactions, a transaction identifier, a seller identifier and a buyer identifier; a program store storing processor implementable instructions; and a processor coupled to the data store and to the program store for implementing the stored instructions, wherein the stored instructions comprise instructions for controlling the processor to: implement a buyer interface to receive a purchase inquiry from a buyer, the purchase inquiry comprising purchase criteria for a product and/or service; output seller offer data for a plurality of sellers, the sellers each being able to meet the purchase criteria for the product and/or service requirement; and receive a purchase request from the buyer accepting an offer of the product and/or service from one of the sellers, thereby creating a transaction, wherein the stored instructions further comprise instructions for controlling the processor to analyze the transaction data to determine stability of at least one market associated with the transaction data, the stability of the or each market being a measure of market liquidity.

The data store may further be for storing market stability data for the or each market.

The or each market may be defined by geographical location of transactions and/or type of good/service which is the subject of transactions. The data store may further be for storing market definition data for the or each market.

A transaction may be additionally created by a purchase inquiry from a buyer not resulting in a subsequent purchase request.

The instructions for controlling the processor to determine stability of a market may comprise instructions for controlling the processor to determine stability of a market based on a total number of transactions in which purchase requests are received from buyers. Alternatively or additionally, they may comprise instructions for controlling the processor to determine stability of a market based on a proportion of buyers that have received seller data of a predetermined minimum number of sellers in response to each of a predetermined minimum number of purchase enquiries. Alternatively or additionally, they may comprise instructions for controlling the processor to determine stability of a market based on a proportion of sellers that have received purchase requests for a predetermined minimum proportion of their offered goods/services. Alternatively or additionally, they may comprise instructions for controlling the processor to determine stability of a market based on a proportion of sellers that each buyer has indicated as being acceptable for their requirements.

The stored instructions may further comprise instructions for controlling the processor to analyze the transaction data to predict future stability of the or each market associated with the transaction data, the future stability of the or each market being a measure of predicted future market liquidity based on predetermined data patterns.

The stored instructions may further comprise instructions for controlling the processor to intervene in a transaction to encourage market stability. The instructions for controlling the processor to intervene may comprise instructions for controlling the processor to intervene based on the determined stability and/or the predicted future stability of a market.

The instructions for controlling the processor to intervene comprise instructions for controlling the processor to subsidize a transaction and/or incentivize the buyer and/or the seller.

The instructions for controlling the processor to intervene may comprise instructions for controlling the processor to intervene based on a financial intervention budget.

The data store may further be for storing historical transaction intervention data.

The stored instructions may further comprise instructions for controlling the processor to identify potential buyers and sellers for intervened in transactions. The data store may further be for storing buyer and seller identifiers of the identified buyers and sellers. The stored instructions may further comprise instructions for contacting the identified buyers and sellers by email and or SMS message.

Instructions for implementing a seller interface and the instructions for implementing the buyer interface may comprise instructions for communicating to sellers and buyers actions that will increase market stability.

The stored instructions may further comprise instructions for analyzing the effect of transaction intervention on market stability.

According to another aspect of the present invention, there is provided a method for managing the purchase of products and/or services by a buyer from sellers, the method comprising: storing in a data store: seller data comprising, for each of a plurality of sellers, a seller identifier and seller offer data indicating at least one product and/or service offered for sale; and transaction data comprising, for each of a plurality of historical transactions, a transaction identifier, a seller identifier and a buyer identifier; implementing a buyer interface to receive a purchase inquiry from a buyer, the purchase inquiry comprising purchase criteria for a product and/or service; outputting seller offer data for a plurality of sellers, the sellers each being able to meet the purchase criteria for the product and/or service requirement; receiving a purchase request from the buyer accepting an offer of the product and/or service from one of the sellers, thereby creating a transaction; and analyzing the transaction data to determine stability of at least one market associated with the transaction data, the stability of the or each market being a measure of market liquidity.

By market stability we mean a state of alignment between the needs of buyers and the offerings of sellers. This may be measured using metrics such as (a) the proportion of sellers who make no sale, or only a minimal sale, within a defined period (b) the number of sellers who fail to sell at least a target percentage of their offerings in the market (c) the percentage of transactions where a buyer gets no available sellers returned for a purchase request. A market of very few transactions can be stable at the present time but it is a perilous state. A further definition of market stability might include a measure of depth in the market. That is, assessing whether there is a sufficient number of transactions in the market in a given time period such that the market is unlikely to experience a disproportionate surge in buying or sellers' offerings that would then make it unstable. Market stability is sometimes referred to as “critical mass”.

### BRIEF DESCRIPTION OF THE DRAWINGS

Embodiments of the present invention will now be described in detail, by way of example only, with reference to the accompanying drawings in which:

FIG. 1 shows a generalised embodiment of a system that might underlie the present invention;

FIG. 2 shows, at a high level, how the present invention interacts with an underlying marketplace of the GEMs type. Shaded areas represent modules in the underlying market;

FIG. 3 discloses modules within the basic version of the present invention;

FIG. 4 illustrates the process of Market Stability Indexing in detail as performed by process Stability Indexing Module 306 in FIG. 3;

FIG. 5 shows an illustrative example of a Market Versatility Table as compiled b process 408 in FIG. 4;

FIG. 6 details the working of Intervention Module Intervention Module 206 as shown in FIG. 2;

FIG. 7 illustrates the key datastores required for both the underlying marketplace and the present invention;

FIG. 8 discloses the workings of the Transaction Specific Intervention embodiment of the present invention;

FIG. 9 discloses the working of the Seller Prioritization process within the Transaction Specific Intervention embodiment of the present invention;

FIG. 10 illustrates the detail of the Participant Management embodiment of the present invention;

FIG. 11 shows the Refined Intervention Indexing embodiment of the present invention; and

FIG. 12 reveals the Investment in Intervention embodiment of the present invention.

### DETAILED DESCRIPTION OF THE UNDERLYING MARKETPLACE

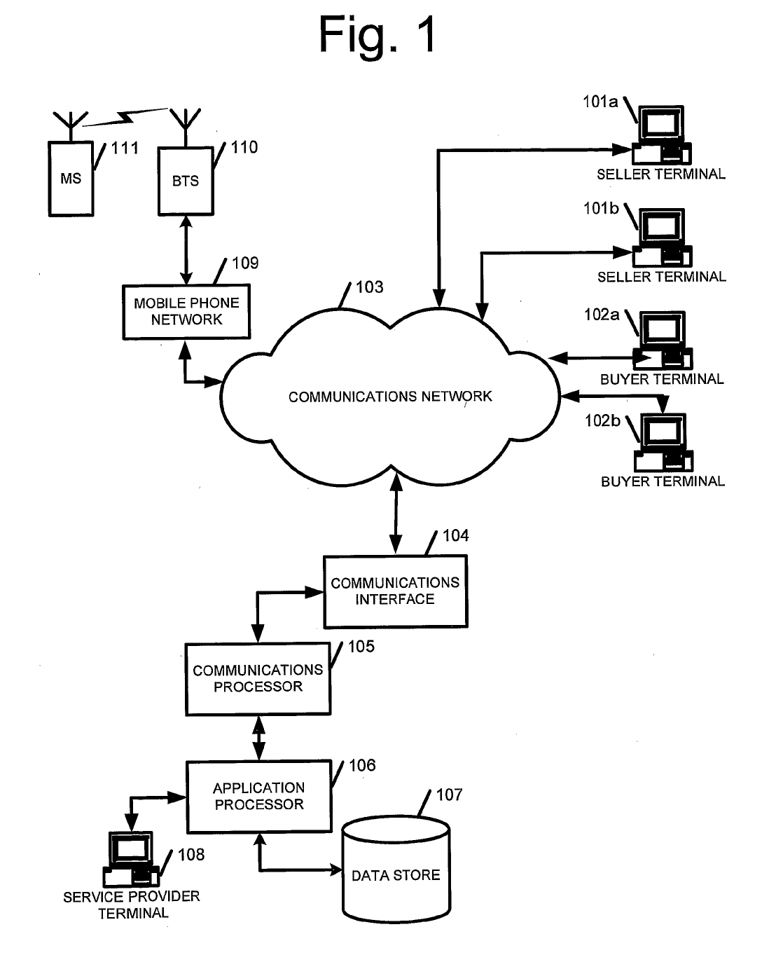

An overview of one embodiment of an electronic markets system will now be provided to illustrate one form of underlying architecture for the present invention. Referring first to FIG. 1, this shows a generalised embodiment of a system that might underlie the present invention. Such a system would run a number of markets in different sectors, examples of sectors might include: secretarial services, office rental and vehicle hire.

A Communications Network 103 is connected to Seller Terminals 101a and b and Buyer Terminals 102a and b and to a System Communications Interface 104. The communications network may comprise any conventional communications network such as a telephone network or the Internet. The communications network couples the buyer and seller terminals to the System Communications Interface 104 to provide user interfaces to the system to allow buyers and sellers to request and execute transactions using the system.

The Communications Interface 104 is coupled to a Communications Processor 105 which creates screens and messages for communicating with buyer and seller terminals 102 and 101. The communications processor is connected to an Application Processor 106 for providing transaction management applications. Application Processor 106 is also coupled to a system service provider terminal 108 to allow a system service provider/operator direct access to aspects of the system to which access via Communications Network 101 is restricted for security reasons. Thus Service Provider Terminal 108 may be used for system management, account management, program code updating, setting a mark-up on each transaction within the system for operator revenue purposes and similar functions. In an alternative embodiment Service Provider Terminal 108 may be connected through a wider communications medium such as the Internet.

Application Processor 106 is coupled to Data Store 107 storing system-related data. It is also able to communicate with external servers that perform specific additional tasks for the benefit of system users. Thus Application Processor 106 can process data for output to buyer and seller terminals 102 and 101 and Communications Processor 107 can access the data to send and receive messages to and from terminals 102 and 101. Thus data in Data Store 107 is indirectly accessible via buyer and seller terminals 102 and 101.

The Communications Interface 104, Communications Processor 105, the Application Processor 106 and the Data Store 107 may all be provided within a single general purpose computer or these functions may be distributed over a plurality of machines in a manner well known to those skilled in the art.

The Communications Network 101 in this embodiment is the Internet to which are coupled Buyer Terminals 102a and b and Seller Terminals 101a and b. Also coupled to Internet 101 is a gateway (not shown) to a mobile phone network 109 (or, more generally, any mobile communications network) which communicates with a Mobile Station 111, such as a phone handset, using base transceiver station 110.

### Relationship of the Present Invention to Processes in the Underlying Marketplace

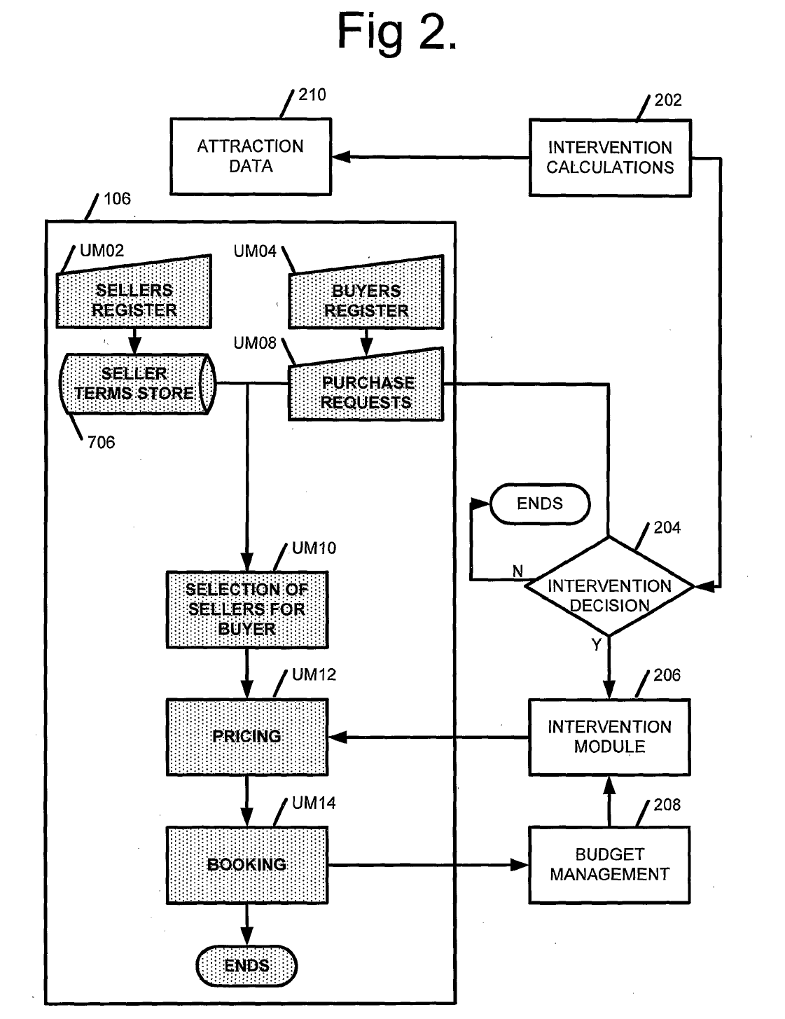

The present invention works alongside an underlying electronic marketplace such as that described above. It's relationship is illustrated at high level within FIG. 2. In this figure, shaded components are numbered UM and signify that functionality is part of the operation of the underlying marketplace. Said functionality is included among those within Applications Processor 106 as shown in FIG. 1.

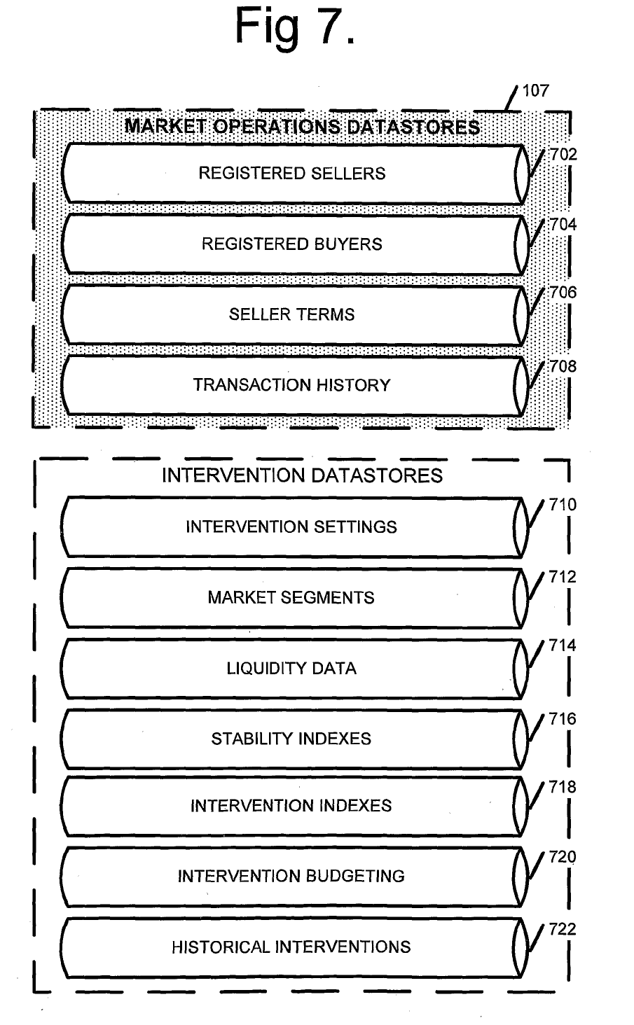

Step UM02 allows new sellers to register. Having done so their details are stored in Registered Sellers Datastore 702 and the availability of their offering, times they are contactable by the marketplace and the terms on which they will sell are stored in Seller Terms Datastore 706. Both datastores are illustrated in FIG. 7.

Returning to FIG. 2. At step UM04 buyers are able to register and have their details stored in Registered Buyers Datastore 704. At step UM08 a registered buyer can raise a purchase request that details: (a) the market sector in which they wish to purchase, for example call centre workers (b) the location at which the purchase is to be consummated, for example the zipcode of the buyer's call centre (c) the dates and times, that is the hours, for which the work is required; by way of example this may be “08.00 to 12.30 tomorrow”.

On receipt of a purchase request, at step UM10, Applications Processor 106 searches Seller Terms Datastore 706 to find sellers who are: (a) offering in the appropriate market sector (b) willing to consummate a purchase in the geography specified (c) available at the hours specified (d) contactable within the period before the start time of the booking (e) willing to fulfil the purchase based on parameters such as the period of notice before it starts or the length of shift.

Step UM12 then calculates the price at which each of the sellers returned by step UM10 will fulfil the present purchase. The buyer is then offered this data and, if he makes a selection involving a commitment to buy one or more of the returned sellers, at step UM14 a booking is initiated. This involves sending notice of the booking to purchased sellers via 105.

### Core Modules of the Present Invention in Overview

Turning now to the unshaded components within FIG. 2; these represent the key modules that interact with the underlying marketplace. They will now be described in brief overview.

Intervention Calculations Module 202 repeatedly sweeps the datastores associated with both the underlying market and the present invention. It applies a set of rules determining the conditions required for intervention of different types and compiles indices that prioritise certain geographies and/or sectors within the market for intervention at any time.

Intervention Module 206 receives details of a purchase request from a registered buyer through process UM08. It compares the present purchase with the current priorities for intervention established by Intervention Calculations Module 202 and decides if an intervention in the present purchase is warranted by the current priorities. If it is not the present invention terminates its process and the transaction proceeds as normal in the underlying market.

If intervention is warranted, Intervention Module 206 is triggered to allocate available funds to subsidizing prices at which the resources of suitable sellers are offered to the buyer. That is, each seller's price for their resource (for example 2 hours of bicycle hire at a particular location) may be higher than the price at which the buyer is offered the resource. The difference will be paid by the funds held by the present invention.

Budget Management Module 208 allocates said funds. For simplicity this document will assume a monetary fund that is transferred electronically. However, it could be a transfer of some other form of value including (a) vouchers redeemable for purchases in the underlying market or elsewhere (b) credits for a game or prize draw of some type (c) a commitment to produce funds once further action is initiated, for example invoicing (d) a period of free, or reduced cost, usage of the underlying marketplace. It is readily apparent the invention can offer a variety of inducements to behave in a particular way.

Budget Management Module 208 confirms to Intervention Module 206 there are funds available before any intervention. Additionally Budget Management Module 208 (a) takes in value to be allocated to interventions, such inputs may be manual for example an input by market operators that allows $10,000 a day to be committed (b) debits amounts that are committed once the buyer decides which options to purchase at step UM14 (c) ensures all details of any intervention that becomes part of a purchase are recorded in Historical Interventions Datastore 722.

It will be appreciated that current priorities for intervention can be used to entice: (a) existing buyers and sellers to transact in the particular geographies or sectors which are now a priority for intervention (b) new buyers and sellers to enter the market to benefit from the intervention. The immediate benefit for buyers is a lower price. The benefit for sellers is an increased likelihood that their resource will be sold if it falls within the current priorities for intervention.

This data can be output through websites and other dissemination channels to attract new market activity which then helps the prioritized geographies/sectors move towards stability. Messages may be targeted specifically at buyers, specifically at sellers or both. Desired recipients may be existing market users, potential market users or both. This task is performed by Attraction Data Module 210 which utilizes Communications Interface 104 to transmit messages it compiles.

Attraction Data Module 210: (a) extracts prioritization data from module Intervention Calculations Module 202, ensuring in each case the priority to be disseminated is backed by cash available to Budget Management Module 208 (b) sorts it by relevant recipients, for example individuals within a certain area who have registered interest in any intervention plans for trading in that area or journalists covering a particular market sector who seek all news of intervention in that sector (c) formats it for dissemination in ways that are well known in the art. Such ways may include (a) emails to parties who have registered an interest (b) automatically updated feeds to websites such as those set up by middlemen or other parties (c) paid advertising targeted at groups most likely to benefit from current intervention priorities (d) automated press releases submitted to dissemination services (e) online syndication services (f) text messages sent to mobile phones of parties who have registered an interest.

### Core Modules in Detail

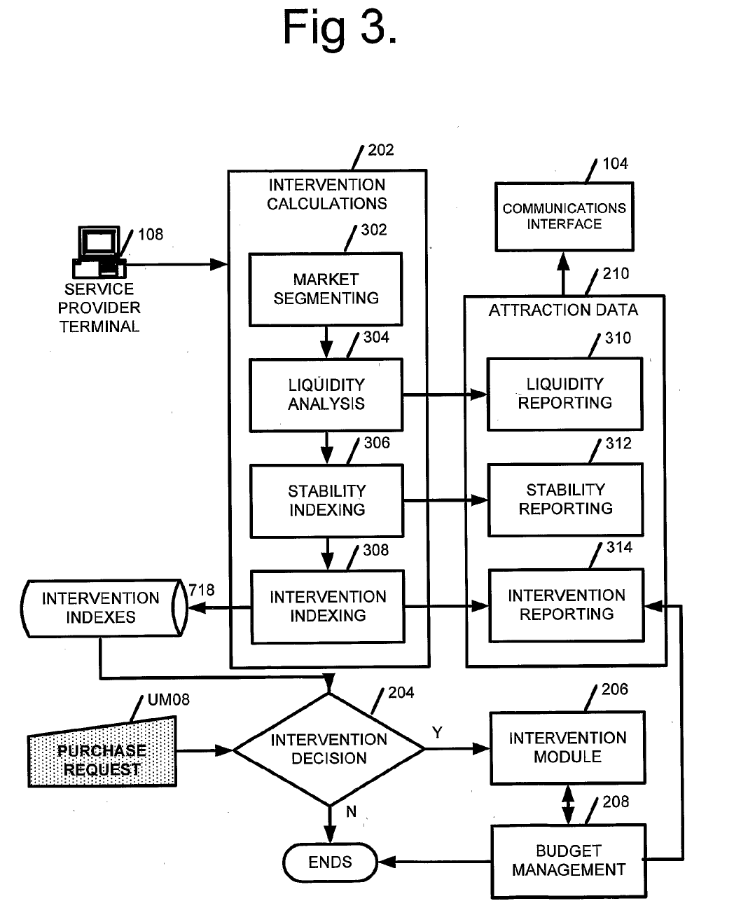

FIG. 3 discloses these core modules within the present invention in more detail. It will be seen that Intervention Calculations Module 202 contains 4 specific processes which feed into Intervention Decision Module 204. Also that Attraction Data Module 210 contains 3 specific processes derived from the current priorities for intervention established by Intervention Calculations Module 202.

These processes will now be listed in detail, starting with the contents of Intervention Calculations Module 202. Some of the settings within this module rely on manual input from Service Provider Terminal 108.

### Building the Grid to Hold Data

Market Segmenting Module 302 compiles the columns and rows of a database which forms the basis for storing further data about intervention priorities. The columns of said database represent types of resource offered in the underlying marketplace. Each row lists a particular geographic point. By way of example a section of the database for a market in the time of rental cars in the UK is illustrated below.

| UK postalcode | Micro | | | Estate | | Luxury |
|---|---|---|---|---|---|---|
| (to 4 digits) | cars | Compacts | Salons | cars | SUVs | Cars |
| E14 1 | | | | | | |
| E14 2 | | | | | | |
| E14 3 | | | | | | |
| E14 4 | | | | | | |

Key settings for the database can be changed by Market Operators using Service Provider Terminal 108. They include (a) new categories of service offering within the market becoming additional columns (b) increased or decreased granularity of geographic points in each row. In a further embodiment, said database may be made more precise by changing the formulation of rows to reflect any combination of: (a) a specific distance from precise postalcodes, the distance may be a factor of current averaged travel distances for the resource in the respective column (b) density of population, thus rural areas are allocated a much wider geographic areas in each row (c) density of registered sellers (d) density of transaction consummation points. The current database is recorded in Market Segments Datastore 712. Liquidity Analysis Module 304 reads data from Transaction History Datastore 708 over a given period specified Service Provider Terminal 108. For simplicity, this period will be assumed to be the last 7 days with data updated once every 24 hours. However, any other time period and updating cycle is possible. It is to be noted the grid outlined above may be extended, for example as either (a) new market sectors are added to the underlying market (b) trading begins in previously inactive geographic areas.

### Liquidity Analysis

Taking the grid in Market Segments Datastore 712, Liquidity Analysis Module 304 allocates each historical transaction to the appropriate cells. Said transactions include a purchase request that returned no sellers. The unique identifier of the transaction may be recorded within the cell. Additionally, this module reads Seller Terms Datastore 706 and allocates the availability of a resource and its travel radius offered by each seller to the appropriate cells. For example, a seller who offered a saloon car for 3 hours within a 2 mile radius of postalcode E6 6EN on Tuesday afternoon last week would cause that offering to be recorded in all rows of Market Segments Datastore 712 where the geographic point was within 2 miles of E6 6EN. In all cases, the unique identifier of each transaction may be recorded alongside the data it yields.

Thus, Market Segments Datastore 712 can be seen to contain details of both offered resource and purchased resource, within each cell's definitions, in the given period. Further calculations by Liquidity Analysis Module 304 will yield the average hourly rate at which the seller was paid for each purchased transaction within each cell.

Also calculated for each cell is the growth, as a percentage, since the last 7 day period of the following: (a) hours of availability offered (b) hours purchased. All this data calculated by Liquidity Analysis Module 304 is stored in Liquidity Datastore 714.

### Stability Indexing

Stability Indexing Module 306 analyses each cell to produce a Stability Index for market activity in that market sector and geography. A stable market segment is one in which: (a) there are enough buyers purchasing enough of the available sellers' offerings to retain seller faith that the market is worth taking seriously (b) the buyers are getting a sufficient enough percentage of their needs met from the resource the sellers wish to sell at the times and terms it is available such that buyers are likely to continue turning to the underlying market for their needs. An unstable cell is one with either (a) not enough purchasing so too much resource availability remains unsold (b) insufficient resource availability so buyers are not getting their purchase requests fulfilled. The Stability Index is a measure of that geography/sector's instability in the previous 7 days or its likelihood of turning unstable in the near future.

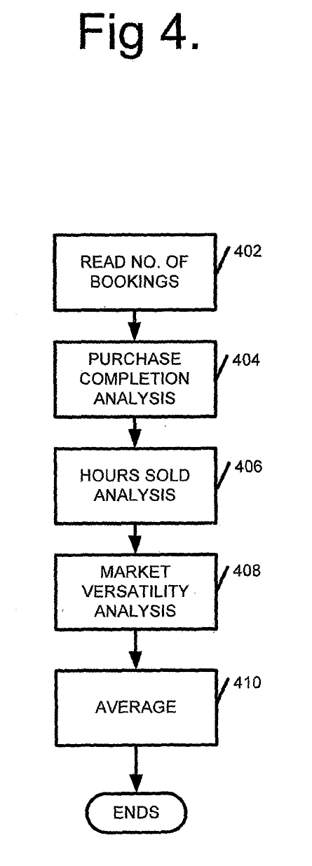

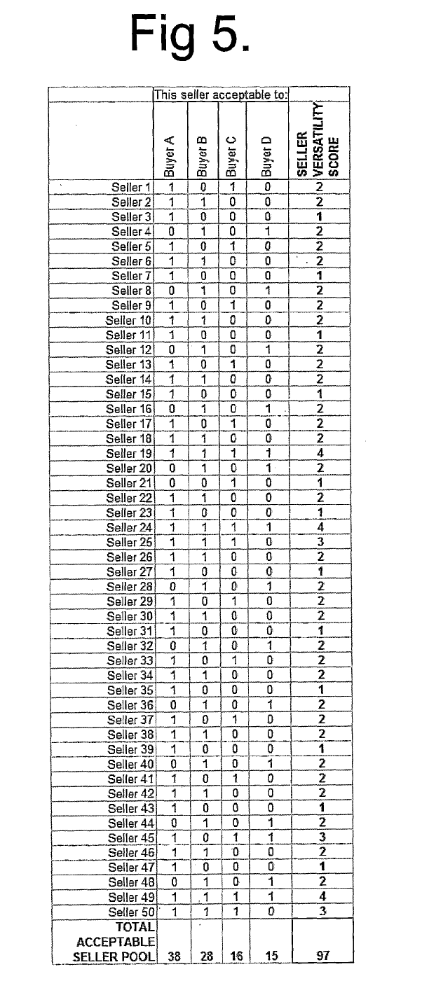

The Stability Index may be a combination of 4 metrics for each cell, any one of which can signify an unstable geography/sector. A process for calculating the Index will now be described in the table below with reference to FIG. 4. Each step involves measuring an aspect of market activity within the designated cell and comparing it against target settings input through Service Provider Terminal 108 and stored in Intervention Settings Datastore 710. The target settings are the figure believed by Market Operators to represent stability in that aspect of market operation over 7 days. These measurements are used to produce a percentage in each case. For example if the No. of bookings is 45 and the target for No. of bookings is 50 the percentage for No. of bookings is 90%. If the Market Versatility target is 50% and the actual figure for a given market segment is 100%, that segment has a 200% ranking against target.

| | | | SAMPLE |
|---|---|---|---|
| REF. | TITLE | CALCULATION | TARGET |
| 402 | No of | No. of bookings with a unique | 50 |
| | bookings | buyer/seller combination | |
| 404 | Purchase | X % of buyers who have had at | X = 75 |
| | Completion | least Y sellers returned for at | Y = 3 |
| | Analysis | least Z % of their purchase requests | Z = 75 |
| 406 | Hours Sold | X % of sellers listing availability | X = 90 |
| | Analysis | have at least Y % of their hours | Y = 25 |
| | | purchased | |
| 408 | Market | Only applicable if buyers are able | Versatility |
| | Versatility | to mark particular sellers as | of 50% |
| | Analysis | acceptable, for example using a | |
| | | seller rating notation against | |
| | | individuals. Measures Market | |
| | | Versatility as shown in FIG. 5. | |

Steps 404 is a measure of dissatisfied buyers. Step 406 captures data about probable dissatisfied sellers. It may be deemed acceptable for sellers to only be selling relatively small percentages of their availability because the unsold spare capacity will enable the market to grow. However, if many sellers are selling no hours they will quickly leave the market. Steps 402 and 408 identify a cell in which buyers and sellers are currently in equilibrium but it is unlikely to remain so, either because there is such a small number of bookings that any further participants will disproportionately destabilize the market or because buyers are so specific in buying selected sellers that there is no fluidity in the market, only mutually exclusive pools of approved sellers being bought in current equilibrium.

The means by which Market Versatility may be simply calculated will now be disclosed with reference to the illustrative table in FIG. 5. The columns list all buyers who have purchased in a geographic location relevant to that cell in the time period under examination. The test of relevance might be: (a) location of consummation of transaction within a set distance of that cell, for example 5 miles, as input by Service Provider Terminal 108 (b) past history of this buyer of purchasing sellers within the present geography. The rows list all sellers who listed availability for sale with a willingness to work in the geographic area covered by said cell in the defined period. Where a buyer has used a system of notating sellers in the underlying market to signify his willingness to hire them said sellers are marked with a 1, non-notated sellers are then marked with a zero. Where a buyer has not used any such system, that is they are not discriminating between sellers they wish to hire and those they won't, all sellers are marked with a 1.

Totaling the columns provides a Total Acceptable Seller Pool for each buyer, that is the number of sellers they did not exclude from their requirements. Totalizing each row produces a Seller Versatility score for each seller, that is how many of the buyers they were acceptable to. This can then be turned into a Versatility ranking by: (a) total all Seller Versatility Scores (b) total the number of sellers (c) divide (a) by (b) to produce a Seller Versatility Index (d) divide (c) by the total number of buyers listed. This produces a percentage Market Versatility Index for the entire cell.

Returning to FIG. 4: At step 410 the 4 percentages may be averaged (totaled and divided by 4) to produce the Stability Index for that cell. This averaging allows for weak indicators to be cancelled out by strong. If the cell is doing well on just one metric, that is likely to cancel out minor weaknesses of any others. The index is recorded in Intervention Indexes Datastore 718. Any cell producing a Stability Index of more than 100% is regarded as stable. That is, there are sufficient transactions, sufficient fluidity and an approximate balance between buyers and sellers. Such a market is likely to have sufficient unsold hours to successfully serve new buyers and enough unmet demand to make listing worthwhile for new sellers.

### Intervention Indexing

Returning to FIG. 3. Intervention Indexing Module 308 takes all cells with a Stability Index of less than 100% and prioritises them for intervention. The key metrics are: (a) progress towards stability in each cell (b) above a minimum number of transactions recorded by step 402, if the figure is too low it may be that market segment needs more time to establish whether there is any prospect of growth; an example of said figure may be 3 transactions a week, it is input through Service Provider Terminal 108.

A market that is moving quickly towards stability is one that justifies increased intervention to push it to 100%. A cell with identical Stability Index that is not growing probably has no further resources or demand to attract and intervention would not serve to increase the size of the overall underlying market. Intervention Indexing Module 308 calculates the rate of growth or decline in each cell's Stability Index. For simplicity this might simply be week on week. This figure is then combined with the Stability Index for that cell. For simplicity, this calculation may simply be a multiplication of percentages with no weighting. Thus a cell with Stability Index of 40% and a week on week growth of 150% has an Intervention Index of 60%. Alternately, weighting these figures to favour growth over stability is easily achieved using formulae known in the art.

It may be that the Intervention Index is capped so that very high Stability Index figures coupled with very high rates of growth do not attract exponentially high Intervention Index figures. Such market segments are likely to be progressing well and need only moderate intervention to push them towards stability. Thus the Instability Index can be capped at a figure entered through Service Provider Terminal 108 and stored in Intervention Settings Datastore 710. By way of example such a figure may be 200%. The figure generated for each cell is stoked in Intervention Indexes Datastore 718.

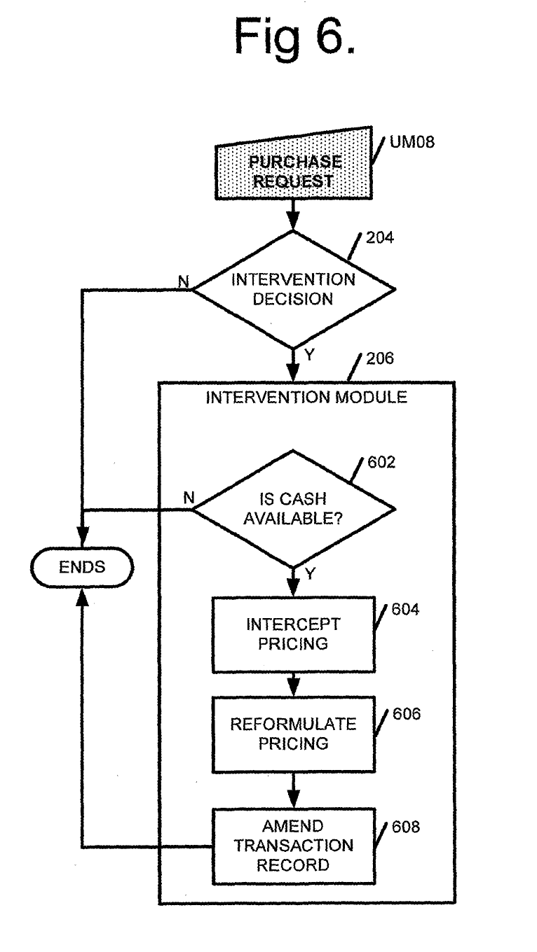

It should now be clear the underlying market has been analysed to produce a series of cells each describing a particular resource being traded in a given geographic area. To each cell is attached an Intervention Index figure expressed as a percentage, this number can be a positive or zero, a negative. This data is updated in regular sweeps of activity in the underlying market and provides the key inputs for Intervention Decision Module 204. This module will now be described in more detail with reference to FIG. 6.

### Intervention Process

The process is started by a Purchase Request UM08 being received. At step 204, the desired purchase is matched with its most appropriate cell within Market Segments Datastore 712. This requires (a) reading the resource required from the buyer's inputs (b) allocating the postalcode of where he wants the resource to the nearest postalcode in the rows of the database (c) possibly averaging data from overlapping cells that include the current postalcode in their definition. The current Intervention Index for that cell, or those averaged cells, is then read. The record may show there is currently no figure signifying either (a) the market described by that cell is deemed stable (b) there has been no previous activity in that cell (c) the market is unstable but not growing thus producing an Instability Index of zero. Where there is no figure the present module will not intervene and the process ends.

If there is an Intervention Index figure, at step 602, the process now consults Budget Management Module 208. It queries the cash available (calculated by a process described below). If there is no cash available the present process ends and there is no intervention.

If there is cash available, at step 604, the pricing process in the underlying market, shown at step UM12 on FIG. 2, is amended as follows. Once the price for each offering for this buyer is calculated that price is discounted by the amount of cash available per offering.

At step 606 this new price is displayed to the buyer and, at step 608, the change is recorded within the record of that transaction. In a further embodiment, step 608 may include a notification to the parties involved in the present transaction that this has been one that has been prioritized as valuable to market stability. They may also be informed of the value of any intervention. Communication could be by: (a) email (b) a notice on the webpages within the market in which the user is informed of the transactions in which they have participated.

### Budget Management

The work of Budget Management Module 208 will now be described in more detail. Its key function is to decide the allocation of cash to be awarded in a transaction which merits an intervention and for which there are funds available.

At it's simplest this could be a flat-rate, for example $1 an hour added to any seller listed in response to any purchase request with a positive Intervention Index. Alternately the market may simply drop its transaction charges on purchases it wishes to encourage because they aid future market stability. More responsive formulas that attune the given cell's Intervention Index figure with the cash allocated will be obvious to those skilled in the art. It could be, for example, that a baseline figure is set of $8 per hour. This is then increased or decreased in line with the size of the Intervention Index figure so that a maximum figure leads to $8 being discounted off the hourly rate displayed to the seller. Smaller Intervention Indexing figures attract a pro-rata reduction. Doing this would ensure the cells with the highest figure, that is the ones which most merited intervention, carried disproportionate incentive for participants.

It is desirable that the entire cost of a general buyer's purchase request not be funded by the present invention. That would erode price competition among sellers because it removes an incentive to undercut other sellers. There may therefore be a fixed component of the price below which it is not discounted. Such a figure, input through Service Provider Terminal 108 and stored in Intervention Settings Datastore 710, might be 25%. That is, the buyer will always be charged at least 25% of the price calculated as the charge for a seller eligible for his booking by step UM12 as shown in FIG. 2. Any portion of the remainder may be funded by subsidy inserted by Intervention Module 206.

Step Budget Management Module 208 is further able to (a) receive allocations of funds through a manual input from Service Provider Terminal 108 (b) be instructed in which cells those funds are to be applied either by identifying the cells which qualify assuming a positive Intervention Index or by setting a threshold for the Intervention Index below or above which funds are not to be spent (c) continuously balance available funds and update Intervention Budgeting Datastore 720 (d) pay out funds when a seller offering in which Intervention Module 206 has intervened is purchased. This last process will now be described more fully.

The purchase of an offering in which there has been an intervention is notified by UM14 in FIG. 2. Budget Management Module 208 then (a) transfers funds to the seller's account to be released when the purchase payment is triggered, for example by completion of a timesheet for the work, this makes up the shortfall in payment from the buyer by the designated amount, if the transaction subsequently fails this sum must be retrievable (b) record the transaction unique identifier and the extent of the intervention in Historical Interventions Datastore 722.

In an additional embodiment, Budget Management Module 208 may not simply allocate funds until it has no cash left to assign. It may begin to proportionately decrease the percentage of desired sum required for intervention once available funds reach a level pre set through Service Provider Terminal 108.

As outlined earlier, Intervention Calculations Module 202 produces data which is used to attract either (a) new market participants (b) desired behavior by existing participants. Said data is compiled by Attraction Data Module 210 which will now be described in more detail with reference to FIG. 3.

### Attraction Data

Attraction Data Module 210 extracts calculations performed by Intervention Calculations Module 202 and targets it as appropriate. With every sweep of the underlying marketplace by Intervention Calculations Module 202 it assembles opportunity information for (a) existing buyers (b) existing sellers (c) new sellers (d) new buyers. This data is classified by sector and geography and then disseminated through a communications network such as the Internet.

Step Liquidity Reporting Module 310 uses information about liquidity in the system to analyse opportunity that may not result in intervention. For example, if sellers are beginning to list in a newly launched boat hire market in Key West that suggests buyers will be tempted to join the market and presents opportunity for anyone in Key West who has registered an interest in local market developments.

Step Stability Reporting Module 312 looks for hot spots of instability that represent opportunity for the under-represented side of the market. For instance, if there is an abundance of bicycle hire offerings at particular times of the week in Birmingham and little buying activity that represents opportunity for anyone who has registered an interest in leisure opportunities, or other meta classification within which bicycle hire falls, in Birmingham.

Finally, step Intervention Reporting Module 314, reports the Intervention Index for each market. Drawing on data from Budget Management Module 208, it also assesses whether cash is available to fund planned interventions. With further input from Budget Management Module 208, Attraction Data Module 210 is thus able to prepare tailored data about current opportunities in the market for onward dissemination.

In an additional embodiment, Attraction Data Module 210 may offer a dynamic interface within users' interaction with the underlying market. This would aim to guide a user to actions that give that user most reward from intervention. For example, a seller inputting their availability for next week could be told of the times when intervention was likely to be in force. Such information could be provided by means of a pop up screen or through a dynamic area of the main screen in the underlying market. Both methods are well known in the art.

### Datastores Underpinning the Present Invention

FIG. 7 discloses the datastores required to underpin both the underlying marketplace and the present invention. Each will now be described:

Registered Sellers Datastore 702 holds details of each seller registered in the marketplace.

Registered Buyers Datastore 704 records every buyer who has registered to make purchases in the underlying marketplace.

Seller Terms Datastore 706 stores the terms on which the offerings of any seller can be bought. They include (a) a definition of the offering, including the sector in which it is to be traded, for example secretarial work where the offering is a person's own time (b) the geographic base of the offering, for example the postalcode of a worker's home (c) the distance the offering can be transported to a buyer's requirements, for instance a worker who will only travel 8 miles from her home address to a place of work, this figure can be infinite in the case of availability for remote working (d) the future dates/times when the offering is available to be bought.

Transaction History Datastore 708 holds a historical record of every transaction in the underlying marketplace, each containing the unique identifiers of buyers or sellers involved. Transactions include (a) purchases (b) attempted purchases where the buyer's Purchase Request returned no eligible sellers (c) availability input by sellers.

Turning to Datastores specific to the present invention. Intervention Settings Datastore 710 holds the current settings for intervention calculations as input by Service Provider Terminal 108.

Market Segments Datastore 712 stores the current, and historic, grids assembled by Market Segmenting Module 302.

Liquidity Datastore 714 records data output by Liquidity Analysis Module 304 which aggregates transaction history in the underlying marketplace to produce patterns of activity.

Stability Indexes Datastore 716 holds the Stability Index for each cell within Market Segments Datastore 712 as calculated by Stability Indexing Module 306.

Intervention Indexes Datastore 718 stores an Intervention Index, positive or negative, for each cell within Market Segments Datastore 712 as calculated by Intervention Indexing Module 308.

Intervention Budgeting Datastore 720 stores data on the funds available for intervention as input by Budget Management Module 208.

Historical Interventions Datastore 722 records all interventions in purchases as processed by Budget Management Module 208.

Thus is should be clear the present invention works with an underlying online marketplace. It is able to: (a) take in a sum of money assigned to increasing transactions in the underlying market (b) analyze activity in the underlying market to prioritise geographies/sectors in which said money can be allocated to most cost effectively increase transactions by moving particular geographies/sectors towards stability between buyers and sellers (c) intervene in targeted transactions to lower prices for buyers (d) disseminate data about its activities so that it attracts market activity (e) perform all cash reconciliation tasks associated with this activity.

### ADDITIONAL EMBODIMENTS

Additional enhancements to, or alternative implementations of, the core functionality previously outlined will now be disclosed.

### Transaction Specific Indexing Embodiment

A problem with the invention as described is that it does not discriminate between particular purchase requests within a geography and sector targeted for intervention. However, some purchase requests have characteristics more likely to attract new market activity. These should be disproportionately subsidised.

Additionally, the invention as described targets all sellers returned for a particular purchase request equally. This may result in some sellers repeatedly benefiting from intervention in multiple purchases in which they are bought. There therefore exists a need for prioritization of sellers so that intervention funds are allocated proportionately to that seller's current danger of contributing to market instability.

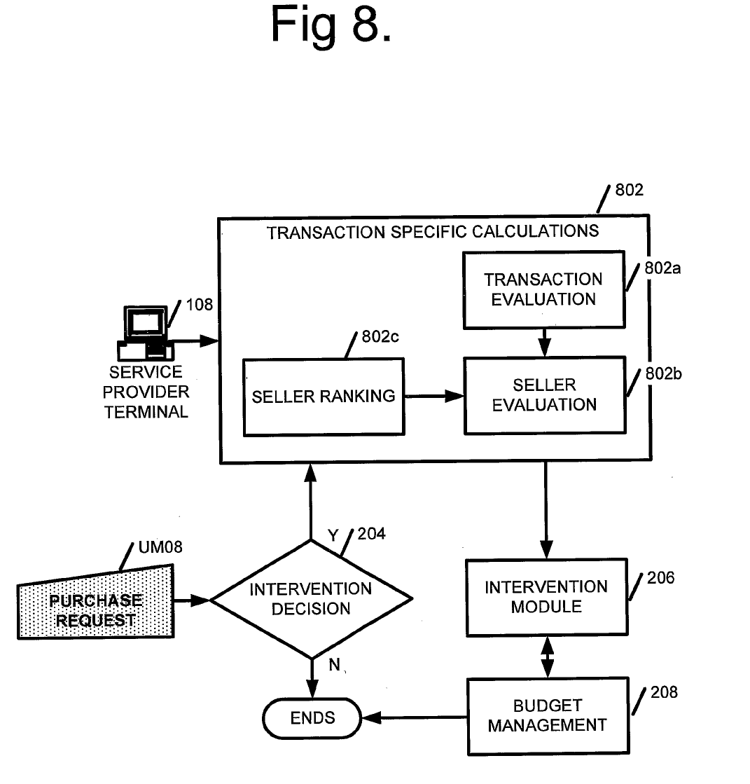

The embodiment that achieves these aims will now be disclosed with reference to FIG. 8. Transaction Assessment Module 802 comprises two additional processes triggered by a Intervention Decision Module 204 deciding to intervene in a transaction. It is supported by a module providing a regularly updated sweep of the seller related data in the underlying marketplace, this provides information for the processes just described.

Step 802a assigns a priority to a particular purchase request based on the likelihood of a purchase with its parameters attracting further market activity. This is a series of weightings that are totaled to produce a figure in ways that are known in the art. Factors used in weighting may include: (a) the length of the booking, that is for how many hours is the buyer seeking a seller or multiple sellers, short bookings are to be encouraged because they create more transactions for the same expenditure and may be subsidized disproportionately (b) the number of available sellers at the time the work is required, purchases made at times when there is high numbers of sellers available are particularly worth encouraging and may be subsidized disproportionately (c) how malleable the requirement is, for example a requirement for 2 hours work to be done “when cheapest” at any point in the next 72 hours is more likely to succeed in a market with few sellers than one specifying an exact start time, therefore such requirements may attract additional subsidy (d) the value of the buyer to the market; high volume buyers, early adopters newly registered buyers or buyers in geographies with high volumes of potential sellers who have registered their interest in joining the marketplace may thus all find their purchases reduced in price because an Intervention Index for the relevant geography and sector has been increased or decreased based on this specific transactions likelihood of contributing to market stability.

Step 802b evaluates each seller returned by UMI0 for the present purchase request. It ensures disproportionately increased price reduction for sellers who are (a) not previously hired by the present buyer so that his purchasing them would increase the pool of sellers experienced in his requirements making him more likely to make further purchases (b) most likely to loose faith in the market if they don't receive a sale shortly (c) exhibiting behavior that helps the market grow.

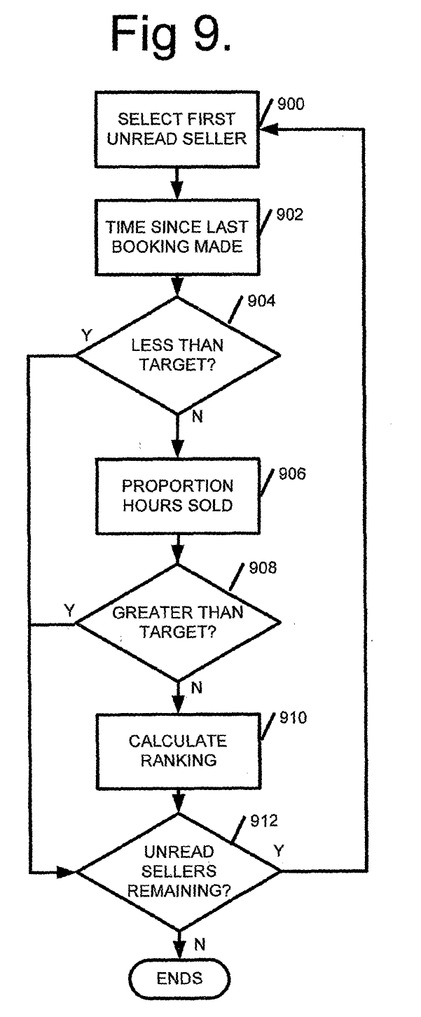

Step 802c generates the background data for the above. It periodically sweeps Registered Sellers Datastore 702, Seller Terms Datastore 706 and Transaction History Datastore 708 in the underlying marketplace. This enables it to produce a list of all buyers for whom this seller has previously sold their time. Those with no previous hires for this buyer may therefore be allocated additional subsidy this being recorded by 802b. Additionally, 802b calculates each seller's likelihood of becoming disenchanted with the market because of lack of sales. This process will now be explained with reference to FIG. 9.

This module requires two target figures be entered through Service Provider Terminal 108: (a) the acceptable period for which a seller can go without sales but is likely to continue to have faith that the market is worth persevering with, for example 7 days (b) the target for percentage of available hours that a seller is expected to sell through the market and a period of over which this can be amortized, for example 25% of hours listed over 4 weeks.

At step 902 the time since last booking is read. This may be the time since the seller was last notified of a booking, not the time since they last carried out a booking which may yet be in the future. At step 904 this is compared to target (a) above. If it is less, the present seller attracts no weighting. If it is greater, at step 904 the number of hours they have listed themselves as available over the most recent period defined in target (b) is read. This is compared to the hours sold in that period. At step 908 this figure is compared to the percentage in target (b). If it is greater the seller receives no weighting. If it is less, step 910 calculates the weighting for the present seller. At its simplest this is just a record that sellers identified are to be offered more cheaply, that is receive disproportionate subsidy for this transaction, than those excluded at steps 904 or 908. More sophisticated formulae may factor in the total past ratio of hours offered to hours sold of each seller, seeking to subsidize any who have no period of heavy utilization to sustain their faith in the underlying marketplace.

Further factors that may be used, at step 910, to produce a ranking of a seller who merits subsidy may include (a) proximity of seller's base postalcode to buyer's postalcode of place of work, this creates local opportunities which are likely to be particularly appreciated by sellers (b) seller's malleability, for example a seller who wants to work 15 hours this week but lists 40 hours when she is prepared to work is contributing more to meeting buyers' needs than one who wants to work 15 hours but only lists 15 hours (c) cheapness for the present purchase request, adding subsidy to such a seller will enhance the savings to the buyer making them more likely to use the underlying market (d) the frequency with which a seller can be contacted by the underlying marketplace, again this increases the accessibility of said seller for buyer requirements (e) defined attributes of the seller such as their current status as a claimant of welfare benefits. Using such assessments it is possible to give each seller who merits subsidy within a potential purchase a percentage weighting which determines the extent to which the Intervention Index for the present transaction is increased or decreased and, consequently, how cheaply they are offered for the present transaction.

At step 912 the process is repeated for any sellers returned for this purchase request for whom the present process has not been enacted.

Thus it will be seen, the present embodiment requires amendments to Intervention Module 206 enabling it to (a) receive instructions pertaining to the present transaction which may differ from other transactions in the same geography/sector (b) intervene to subsidize the price of each available seller at a different rate. Likewise Budget Management Module 208 will be required to store more specific data after a purchase in which the present invention intervened.

It is to be noted that the present embodiment may be used in isolation from most of the functionality offered by the present invention. That is, it could be used to allocate intervention funds to sellers who were in danger of loosing faith in the underlying market regardless of the stability of the market segments in which they traded.

In an alternative implementation of the present invention, the present embodiment could stand alone. That is, operate without the present invention as previously described.

In a further embodiment, transaction specific attraction data could be used to present information to a user as they transacted in the underlying marketplace. Thus, by way of example, a buyer inputting requirements to purchase could be informed, by means of a pop up screen or other presentational device, that their intended purchase would attract greater intervention cash if it were formed of shorter booking periods. Likewise a seller could be reminded on their home page that they would be likely to qualify for intervention next week if they received no bookings, despite listing availability, this week.

### Participant Management Embodiment

As the market underlying the present invention grows it will attract new buyers and sellers. This growth can create instability that then causes new participants to vacate the market. For example, if a flood of sellers enter a particular market segment with no corresponding increase in buyers they are likely to find listing their hours of availability fruitless. If Market Operators are committed to intervention to achieve stability, costs will then be incurred ensuring these sellers attain even the bare minimum of sales deemed necessary to retain their commitment to the marketplace.

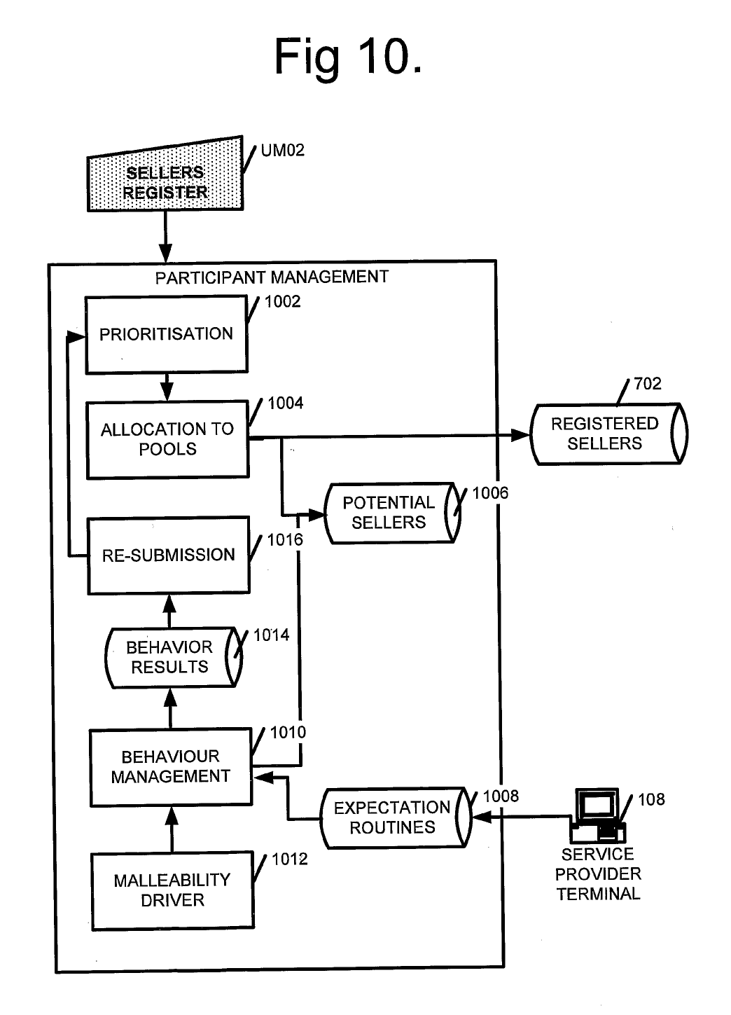

To avoid these costs the present embodiment (a) prioritizes new sellers, allowing only those most likely to make sales to enter the market at once (b) manages the expectations of those who can not be allowed immediately into active trading (c) encourages behavior among all potential sellers that increases stability in the market. In an alternative embodiment, the same processes could be applied to buyers in a market short of sellers. For simplicity this disclosure will explain in terms of sellers only. The explanation is to be read with reference to FIG. 10.

When a new seller registers in the underlying market through UM02 as shown in FIG. 2, their application to join the market is processed by the present embodiment. At step 1002 the new seller is awarded points. The process weighs their (a) geographic base and sectors in which they wish to sell, if Liquidity Datastore 714 shows their chosen market segments have an above target Hours Sold Analysis as calculated at step 406 in FIG. 4, high points will be awarded (b) track record in related online markets if known, for example they may already have been active in another geography or sector in the underlying market and demonstrated a good record of reliability, this makes them attractive to buyers and therefore to market activity and high points will be awarded (c) evidence of behavior that indicates they will take their commitments to the market seriously and therefore be attractive to buyers, this could be established by methods outlined below (d) days and times of availability that mirror current patterns of purchases, as stored in Liquidity Datastore 714, in their indicated geography and sectors (e) endorsement by middlemen providing registration of buyers or sellers in the underlying marketplace.

Step 1004 maintains a table of points required to enter the pool of current sellers. Assume possible points awarded to each seller range from 0 to 100. It may be that 75 points or above allows a seller to go direct into 7o2. Below that entitles them to be registered in a pool of potential sellers in Potential Sellers Datastore 1006.

Step 1004 also reads data from Liquidity Datastore 714 after every sweep of the underlying marketplace as outlined at step Liquidity Analysis Module 304 in FIG. 3. This is used to lower or raise the threshold for admittance to each pool and move sellers between pools. Thus if Liquidity Datastore 714 shows an increase in demand for van drivers in Boston since the last sweep, all Boston based van drivers in pool A and B are re-prioritized and the highest ranked admitted to Registered Sellers Datastore 702 in proportion to the increase in demand.

Once sellers are allocated to Potential Sellers Datastore 1006 they are managed automatically. The aim of this management is: (a) to maintain their interest in becoming an active seller in the underlying market until such time as their prioritization ranking rises or the entry threshold falls for them to be transferred to Registered Sellers Datastore 702 (b) to actively prepare the higher priority sellers for market entry once appropriate buyers have emerged (c) educate waiting sellers and reward behavior that will benefit the underlying market once sellers are active in the underlying market.

At step 1008 is a record of Management Routines entered through Service Provider Terminal 108. These are processes for contacting sellers or potential sellers to achieve the aims above. One aim is to constantly inform the potential seller of their prioritization and the likelihood of it resulting in entry to the main market shortly. Contact may be through (a) email (b) text messages to mobile phones (c) a requirement the potential seller log on to a given website at stipulated times. Behavior required might include: (a) responding to messages sent at times the individual has committed to being contactable promptly to confirm receipt then later logging onto a particular website and inputting a confirmation code sent in the text message at times they have indicated they would be available (b) responding to test messages from the present embodiment at times the seller has indicated they can be contacted. Active sellers may be urged to increase their hours of availability, or align them with patterns of purchase as shown by Liquidity Datastore 714.

Desired behavior may then be rewarded with cash, vouchers, entry into a prize draw or other inducements of value. Additionally, if the underlying marketplace grades its sellers on a matrix that recognizes reliability, potential sellers may climb those grades by responding promptly to messages or logging-on at times specified in such a way that it demonstrates conscientious behavior.

Step 1010 implements these routines in periodic sweeps of Potential Seller Pool 1006 and Registered Sellers Datastore 702. It draws on step 1012 which looks to increase the malleability of active sellers and the potential malleability of potential sellers. That is, it seeks to reward changes by the individual that make them more aligned with market need. Such changes might include: (a) increasing hours of availability each week (b) increasing times when contactable (c) willingness to list their offerings in sectors related to their current choices (d) changing their terms of sale, for example by removing restrictive personal parameters such as a refusal to do bookings with less than 2 hours notice (e) expanding the radius from their base postalcode which they will travel to a buyer. The communications and reward routines that drive this behavior are incorporated into step 1010.

Each individual's responses to these communications are stored at step 1014. This will include: (a) communications sent to the named individual (b) the invitation to action, for example responding within a certain time or logging onto a website and entering a password at a given time (c) extending the seller's terms. Periodically, step 1016 will re-submit individuals with acceptable responses to step 1002 for re-prioritization.

Thus, the present embodiment is able to manage a pool of sellers and potential sellers, encouraging desired behavior but only allowing sufficient numbers of sellers into the underlying marketplace to keep it within its defined stability boundaries. Management of buyers in this way is less of a priority assuming the stability definition is set to include a high percentage of spare seller capacity into which the underlying market can grow. Additionally, it is unlikely the marketplace will require an ongoing commitment analogous to listing availability, and keeping that time free, that may be required from sellers. A buyer who find the market has no spare capacity has only wasted the time taken to input his purchase requirement. His faith will not be as dented as a seller who has kept several days free for work and received none.

### Refined Indexing Embodiment

The Intervention Index as described thus far can be refined further. It could address a variety of market patterns within a geography and sector that indicate for example a sector in which any of the following apply: (a) stability increases in periodic spurts while the underlying pattern is stable (b) funds intended for stabilizing the market would be more effectively spent in other sectors (c) stability could be achieved more cheaply by meeting patterns of demand shown by purchase requests that returned no sellers (d) stability is hindered by specific parameters of transactions, for example buyers' need is for short notice purchases and large numbers of otherwise eligible sellers are being excluded because they are unwilling to do said transactions.

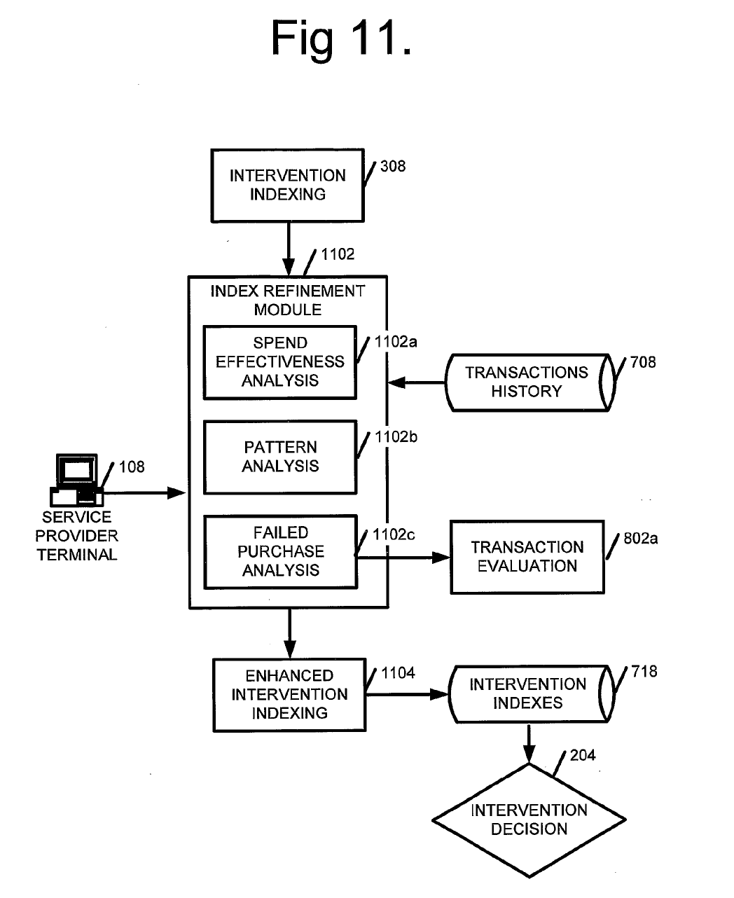

The present embodiment will be described with reference to FIG. 11. It receives the outputs of Intervention Indexing Module 308 as illustrated in FIG. 3 and further processes them to create a more refined Intervention Index figure for each cell generated by Market Segmenting Module 302 in the same figure. This refined figure is then stored in Intervention Indexes Datastore 718 and thus acted on by Intervention Decision Module 204. The refined figure also forms the basis for data utilized by Attraction Data Module 210.

Index Refinement Module 1102 contains a plurality of processes, each monitoring activity in the underlying market by accessing Transaction History Datastore 708. Samples of such processes will be outlined with reference to FIG. 11.

Step 1102a seeks market sectors in which there are repeated peaks in the Stability Index that, taken in isolation, repeatedly suggest a market worth significant intervention. But, when viewed as a historical pattern, are only fluctuations around a slow or non-existent increase in Stability Index. Furthermore, this process can analyze the return on funds spent on interventions.

To do this, for each cell within Market Segments Datastore 712, the process builds a grid with historical 7 day periods, or other selected period, as columns. The following rows are then populated for each column: (a) Stability Index in that period, extracted from Stability Indexes Datastore 716 (b) percentage growth or decline in Stability Index since the previous 7 day period (c) amount spent on interventions within specified cell in that 7 day period (d) amount spent to achieve 1% of growth in Stability Index in each 7 day period or amount spent that achieved no growth or decline in Stability Index (e) analysis of cost of each 1% growth in Stability Index over a period entered by Service Provider Terminal 108, or cash spent against decline or stagnation in Stability Index in said period.

Using this grid it is possible to produce a metric for each cell expressed as $1 has bought X % of Stability Index growth, or expenditure has produced no growth over the given period. This can be used to re-weight the Intervention Index for that cell using a scale input through Service Provider Terminal 108. By way of example, all cells which produced no growth in Stability Index have their Intervention Index set at zero. Those which produced some growth are placed in descending order with the highest growth cell awarded 200%, the lowest given 1% and the rest ordered proportionately between. The percentage awarded is then used as a multiplier of their unrefined Intervention Index as calculated by Intervention Indexing Module 308 before storage in Intervention Indexes Datastore 718.

Step 1102b searches for patterns of instability that can be linked to either: (a) dates/times (b) information from an external source such as weather report data. This enables it to predict such instability and trigger intervention in anticipation. Using the grid compiled by the previous process, it looks for sudden falls in Stability Index of perhaps, greater than 50% and taking the market sector below an Index of 100%. It analyses the dates on which these fall and seeks a recurring pattern. Additionally it seeks to compare the dates of such falls with data from an external source, looking for a correlation of data in ways that are well known in the art. Where such a pattern is predicted by dates, for example because the fall has happened in the same week every year for the past 5 years, the process may increase the index by a comparable amount in the same week in the present year.

Likewise if there is a correlation between falls in stability and figures for dates from an external data source it will increase the Intervention Index when such a fall is forecast by the external data. An example of this might be a market in hire of tents which correlates to peaks in local sunshine records. This could merit an increase in Intervention Index for that market that would last until either: (a) the sunshine-hours-per-day data fell off its peak (b) the geography and sector achieved stability. Increases in the Intervention Index by this process would probably be independent of any adjustment by process 1102a.

In a further embodiment, step 1102b could search for likely patterns of instability based on future availability and likely purchases. To do this it would read Transaction History Datastore 708, as shown in FIG. 7, to populate a copy of Market Segments Datastore 712 with future hours of eligible availability entered at the present time. This would be compared to historical data on patterns of transactions stored within Liquidity Datastore 714. Where there was a clear shortage of availability, for example the following week, an Intervention Index commensurate with the scale of the gap could be created within Intervention Indexes Datastore 718 and publicized through Attraction Data Module 210 in FIG. 2.

Process 1102c examines purchase records stored in Transaction History Datastore 708 that returned a number of sellers below a target figure entered through Service Provider Terminal 108. Such a figure may be one. It repeats the search for sellers carried out by UM10 using data that would have been available at the time now stored in Transaction History Datastore 708. It produces a list of sellers who were rejected from that search because of any of the following parameters: (a) within the maximum travelable distance for that sector but seller has personally opted for a smaller travel distance (b) unwillingness to do bookings at the short notice required (c) unwilling to do bookings of the short length required (d) unavailable at the time of the booking (e) uncontactable at the time of the booking (f) any other parameters of sale accepted by the underlying market. These reasons for exclusion are tabulated and totaled. This will produce a prioritized list of reasons why sellers in Registered Sellers Datastore 702 and likely to be eligible for said purchase were unavailable because of their personal preferences recorded in Seller Terms Datastore 706.

In conjunction with the Transaction Specific Indexing Embodiment as outlined earlier, the data generated by process 1102c can be used to weight intervention in individual transactions that have the characteristics not currently being displayed by sellers. For example, if there are few sellers willing to work at short notice in a given geography/sector intervention may be increased by 75% on transactions with a short notice requirement until the appropriate Stability Index reaches 100%. The present embodiment's intention to do this would be communicated to sellers through Attraction Data Module 210 who should then be tempted to change their settings and experiment with new parameters.

### Seller Bonus Embodiment

Descriptions to this point have assumed intervention takes the form of cash used to reduce the price charged to the buyer, thus attracting more buying power which makes the market increasingly attractive to sellers. However, where the problem is lack of seller willingness to comply with existing demand from buyers, as sought by process 1102c above, it may be more appropriate to allocate intervention cash to paying the seller a bonus over their charged rate. This could be a percentage of their charge to the buyer, which has to remain competitive or the buyer would be likely to select another seller who would also be bonused. Seller bonuses would be calculated by Intervention Calculations Module 202 and awarded by Intervention Module 206 with transaction administration carried out by Budget Management Module 208. All three are illustrated in FIG. 2

### Anti-Collusion Embodiment

An intention of the present invention is that sellers and buyers be encouraged to act in ways that will increase stability in the underlying marketplace. Attraction Data Module 210 encourages the desired behavior by advertising the geographies and sectors where transactions are currently being subsidized. This may lead to individuals entering the market solely to benefit from the intervention cash although, given the geographic and sector entry qualifications and time taken to register, the switching costs of leaving the market once intervention ceased should minimize this problem.

A problem does occur however if a buyer and seller collude to appear to make a purchase in the underlying marketplace but not then don't physically transact. That is, the seller lists availability and terms of sale in a market sector which currently carries a high Intervention Index. The buyer then purchases the seller with whom he is colluding and pays for their offering but both parties have agreed no offering will be provided. They then share the intervention cash.

The present embodiment aims to close this possibility. It: (a) rates buyers and sellers for genuineness, that is a pattern of purchases or sales with a plurality of counterparties in the underlying marketplace if one or both have no such track record intervention may be reduced or withdrawn (b) records buyer/seller pairings in transactions with a positive Intervention Index and does not intervene in any second purchase of a seller by a buyer to whom they have already sold within a given timeframe.

### Investment in Intervention Embodiment

The invention as disclosed thus far assumes the funds for intervention will be provided by Market Operators as a loss leader to assist their markets towards stability as quickly as possible. The costs will then be recouped in operators' fees charged on a stable, growing market. The present embodiment provides an alternative way of funding intervention, by allowing any external investor to define the types of intervention in which they are interested and obtain a return by adding a small mark-up on each transaction in the stable, growing, market that ensues. There are alternative arrangements for obtaining a return on electronic market operations such as market usage charges and is readily apparent how they may be used to generate revenue which benefits from the present invention.

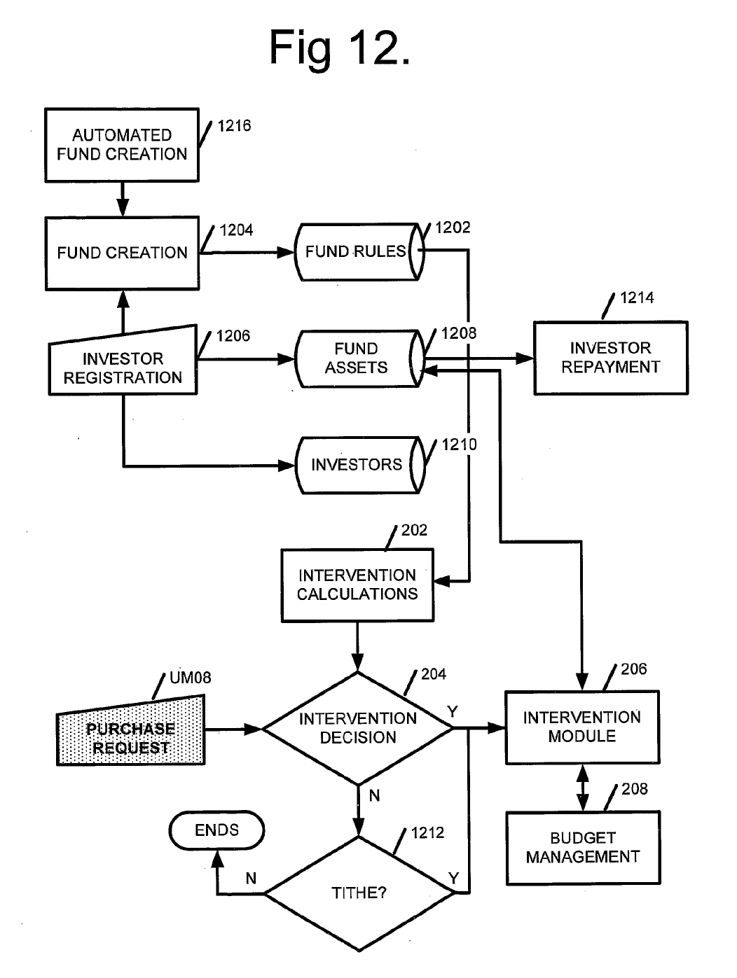

This embodiment will now be explained with reference to FIG. 12. This shows one form of processes of enabling intervention driven by investment as they relate to the core process of intervention outlined previously.

Datastore 1202 contains the rules that determine each of a plurality of investment funds dedicated to intervention. Said rules for each fund describe the requirements of a transaction in which this fund will intervene to lower prices with subsidy. Rules may be a combination of: (a) the geography of place of sale (b) the sector within the market (c) characteristics of the purchase for example times of day the work is to be provided (d) characteristics of seller to benefit from intervention, for instance their base postcode or a minimum or maximum number of previous transactions (e) the current Stability Index figure for the appropriate geography and sector (f) current Intervention Index figure for the appropriate geography and sector (g) historical pattern of either Stability or Intervention Indexes (h) a possible maximum number of transactions to be subsidized. Anyone setting, or any combination of settings, within the list may be “all”.

Thus an investor who believed the market for Home Care Assistants in Atlanta could quickly be bought to stability might chose to invest in intervention in any transaction with an Atlanta zip code where the purchase was for Home Care and the period of work less than 4 hours while the Stability Index for the purchase request zip code was greater than 60%. The establishment of such a fund, and its current assets would then be disseminated to target beneficiaries through Attraction Data Module 210 as already described.

The rules may additionally define the maximum amount to be paid out in subsidy for any one buyer/seller interaction. And they may define the terms on which a return will be generated by tithing market activity, that is adding a mark-up percentage to each transaction with the characteristics defined in the rules above once stability in the geographies/sectors covered has been reached a Stability Index of 100% or above. In one embodiment, market operators may set a fixed percentage tithe on each transaction of perhaps 2%. This would stop unscrupulous investors charging very high percentages that make the market uncompetitive as soon as it is stable.

Thus, each fund defined within Datastore 1202 will include an entry for: (a) the Stability Index figure at which tithing will begin, for example 125% would allow the market to go beyond basic stability before having to bear the tithing charge, said figure may be set by market operators to avoid too early a start to tithing (b) the period of tithing, for example 6 months from first reaching a 150% Stability Index (c) the Stability Index figure below which tithing stops, for example if it falls below 120%, again this may be set by market operators (d) is the period of tithing inclusive of any halts in tithing because of falls in stability or exclusive? (e) once the fund has switched into tithing mode will it return to subsidizing purchases if the appropriate market/sector becomes unstable and, if so, how does this impact the tithing period?

These funds can be established at step 1204. This will offer a potential investor the chance to establish a fund with his own rules but refuse to register one that covers a geography/sector currently with a Stability Index of 100% or more. An investor registering at step 1206 would also have the option of investing in existing funds if they had not yet switched to tithing mode. The investor is required to stipulate: (a) an account into which earnings are paid (b) how she would like repayments aggregated. Said investor transfers cash, or other store of value, into 1208, a datastore of assets held by each fund. The new investor is recorded in 1210 datastore of investors.

The present embodiment requires changes to the Intervention process as outlined in FIG. 3. Intervention Calculations Module 202 is modified so that it will read from Fund Rules Datastore 1202 to see if the present UM08 is one in which a fund: (a) has been established that wishes to intervene (b) has the cash in Assets Datastore 1208 to do so. If both are the case the intervention will follow the rules of the appropriate fund.

It will be appreciated Intervention Calculations Module 202 may have to choose between competing funds wishing to intervene in a particular transaction. When this is the case the fund that offers the market the best value may be accessed, for example because it has the shortest tithing period after stability is reached.

Intervention Decision Module 204 is also modified so that, if an intervention in the present transaction is not required, at step 1212 the present embodiment will check whether the present transaction is one that should be tithed. That is, it fits the parameters of one of the funds in Fund Datastore 1202 but the market segment currently meets the requirements for tithing. In such a case the charge is added onto each seller's price before being displayed to the buyer. Any seller offerings then purchased are marked by Budget Management Module 208 to have the tithing component deducted as the value is transferred. It is then credited to that fund's record in Assets Datastore 1208. Where the present transaction is within more than one fund's parameters the rule may be that the one with the shortest tithing period is credited, or there is a split between those with equal periods. Alternately, the cash could be credited to the most tightly defined fund, currently at tithing stage, that incorporates the present transaction. That is, the fund which has the smallest geographic/sector reach. This will incentivise funds that add precise human knowledge about likely market development to the system's own processes.

The present embodiment requires that Historical Interventions Datastore 722 be modified to include a record of funds involved in any intervention. Step 1214 of said embodiment enables the repayment of funds to investors accounts, aggregated as they have indicated, as a fund moves to the tithing stage. The means for this transfer of value from system to selected users are well known in the art.

As a further enhancement, at step 1216, the embodiment may automatically generate fund records that mirror geographies/sectors where Intervention Calculations Module 202 is currently identifying the most profitable opportunities for intervention. This would save investors from needing to read the output of Attraction Data Module 210 before deciding where the new opportunities where to be found.

### Automated Tithing Embodiment

A variant of the Investment in Intervention embodiment provides for automatic tithing to replenish a central fund with no external investors involved. In this embodiment, tithing of a stable market to pay for earlier intervention is automated for a fixed period. Thus, Intervention Calculations Module 202 decides when to intervene in a transaction based on funds accessible to Budget Management Module 208. Said funds are replenished by the tithing at step 1212 in FIG. 12 which may operate on any transaction with a Stability Index above a certain figure input through Service Provider Terminal 108. More complex formulae for automated tithing of stable market segments to fund intervention in unstable market segments will be obvious.

### Automatically Created Transactions Embodiment

In some circumstances it may be to the benefit of market operators, and potentially investors as previously described, to fund 100% of the costs of certain transactions. That is, to artificially create purchases for a limited period. It is to be noted that this would be badly achieved by subsidizing general buyer's purchase requests to 100% because that would remove price competition between sellers. Instead, the present embodiment itself acts as a buyer which makes rational cost-based decisions about which sellers to purchase based on calculations by Applications Processor 106 as illustrated in FIG. 1.

The value of the present embodiment is that it can: (a) guarantee potential sellers the likelihood of a sale (b) attract buyers who wish to know there is a pool of active sellers before registering (c) create a rapid start to market activity that might otherwise be paralyzed while buyers wait for sellers to become established and vice versa. The present embodiment, sits within Intervention Calculations Module 202 and would act for a short period of time, 12 weeks for example, while progressively being displaced by the normal processes of the present invention.

Such totally funded transactions could be automatically initiated by an exceptionally high Instability Index for a particular sector and geography or, more simply, by the manual allocation of a discrete and finite pool of cash. This embodiment requires that a pool of work be identified, possibly in response to online applications, for which sellers will be employed in ways that most benefit a move towards market stability. This work, possibly for a charity project, is the work of last resort; if no buyers enter the market, sellers will be employed by this embodiment, through the underlying market, to do the work.

The present embodiment is most likely to be useful: (a) in the earliest days of the underlying market when there is a need to establish a seed of activity from which wider activity can grow (b) when new geographies or sectors are launched (c) when a market segment has collapsed through instability caused by unusual circumstances and needs to be re-started. In either case triggering could be automatic with a finding of no, or minimal, activity in a given cell of Market Segments Datastore 712 by Liquidity Analysis Module 304. Small sums could be allocated, and publicized through Attraction Data Module 210, with Refined Intervention Indexing Embodiment ensuring funds were soon cut off if they produced no move towards stability.

To act, the present embodiment needs definitions, either manually entered through Service Provider Terminal 108 or automatically generated from analysis of Intervention Settings Datastore 710 and combined with funds accessible to Intervention Budgeting Datastore 720. They include: (a) a geography for intervention defined (b) a market sector for intervention defined (c) a maximum and minimum sum controlled by Budget Management Module 208 which is allocated to this market segment (d) buyer details and reporting instructions for the work to be wholly funded (e) a start date and possible cut off point in time when intervention by this embodiment is to cease and the normal processes of the present invention take over (f) rules covering thresholds at which transactions are to be created, for example mirroring the target for a given percentage of seller hours to be sold for minimum stability to be achieved as measured by Stability Indexing Module 306 (g) parameters of purchases to be created, for example that they be of only 2 hours duration so funds are spread among as many transactions as possible (f) priorities for creating purchases when work that is wholly funded by this embodiment is purchased, this can be defined either by times of day and days of the week or, more usefully, in terms of when the purchase will most aid a move towards market stability for instance purchasing at times when there is the least seller availability thus encouraging sellers to list availability at times which will increase the overall range of availability making the market more attractive to buyers.

By way of example: the embodiment could be targeted at the market for general laboring within 5 miles of central Cambridge. A fund of $5,000 dollars is input with first transaction on January 1^{st} and a maximum duration of 100 days. Its aim is to achieve a minimum 30% utilization in alternate weeks of the first 250 sellers to enter the market, registrants beyond this number being held in the Participant Management Embodiment as illustrated in FIG. 10. If transactions must be created to achieve this the buyer will be a project renovating a local housing shelter. As with all intentions created by Intervention Calculations Module 202 the plan would be publicized through Attraction Data Module 210. Any other buyers would be free to enter the market and purchase the spare availability of said sellers with Participant Management Embodiment feeding new sellers into the market to keep seller utilization within acceptable targets.

Additionally, the present embodiment may try to both: (a) maximize the impact of its funds (b) accelerate take up by buyers. It can do this by using said funds to subsidize additional buyers in decreasing amounts relative to the point at which they enter the market. Thus the first buyer into the market may be offered prices for his first transaction that are 99% discounted on the full market rate based on each seller's terms as pricing parameters as recorded in Seller Terms Datastore 706. The second seller is offered a 98% discount for his first purchase and so on. This process would work best if administered by Transaction Specific Indexing Embodiment as previously described. Clearly buyers could be expected to register and prove their credentials as likely ongoing users of the marketplace before benefiting in this way.

Intervention in the market in this way would be included in the grid compiled by Refined Intervention Embodiment described earlier, this would ensure intervention was aborted at the end of any fixed period if it was not producing growth towards stability. It should be noted that this embodiment is intended to work with Investment in Intervention Embodiment outlined earlier. In this way it would allow potential investors to seed new markets and then take a return from tithing on the stable market which then emerges.

It is to be noted that both Investment in Intervention Embodiment and Automatically Created Transactions Embodiment may be utilized by organizations with non-financial motives for seeding new market activity. They include government agencies keen to see new markets emerging in areas of worklessness for the good of the local community.

1. A transaction management system for managing the purchase of products and/or services by a buyer from sellers, the system comprising:
a data store for storing:
seller data comprising, for each of a plurality of sellers, a seller identifier and seller offer data indicating at least one product and/or service offered for sale; and
transaction data comprising, for each of a plurality of historical transactions, a transaction identifier, a seller identifier and a buyer identifier;
a program store storing processor implementable instructions; and
a processor coupled to the data store and to the program store for implementing the stored instructions, wherein the stored instructions comprise instructions for controlling the processor to:
implement a buyer interface to receive a purchase inquiry from a buyer, the purchase inquiry comprising purchase criteria for a product and/or service;
output seller offer data for a plurality of sellers, the sellers each being able to meet the purchase criteria for the product and/or service requirement; and
receive a purchase request from the buyer accepting an offer of the product and/or service from one of the sellers, thereby creating a transaction,
wherein the stored instructions further comprise instructions for controlling the processor to analyze the transaction data to determine stability of at least one market associated with the transaction data, the stability of the or each market being a measure of market liquidity.

2. The system of claim 1, wherein the data store is further for storing market stability data for the or each market.

3. The system of claim 1, wherein the or each market is defined by geographical location of transactions and/or type of good/service which is the subject of transactions.

4. The system of claim 3, wherein the data store is further for storing market definition data for the or each market.

5. The system of claim 1, wherein a transaction is additionally created by a purchase inquiry from a buyer that does not resulting in a subsequent purchase request.

6. The system of claim 1, wherein the instructions for controlling the processor to determine stability of a market comprise instructions for controlling the processor to determine stability of a market based on a total number of transactions in which purchase requests are received from buyers.

7. The system of claim 1, wherein the instructions for controlling the processor to determine stability of a market comprise instructions for controlling the processor to determine stability of a market based on a proportion of buyers that have received seller data of a predetermined minimum number of sellers in response to each of a predetermined minimum number of purchase enquiries.

8. The system of claim 1, wherein the instructions for controlling the processor to determine stability of a market comprise instructions for controlling the processor to determine stability of a market based on a proportion of sellers that have received purchase requests for a predetermined minimum proportion of their offered goods/services.

9. The system of claim 1, wherein the instructions for controlling the processor to determine stability of a market comprise instructions for controlling the processor to determine stability of a market based on a proportion of sellers that each buyer has indicated as being acceptable for their requirements.

10. The system of claim 1, wherein the stored instructions further comprise instructions for controlling the processor to analyze the transaction data to predict future stability of the or each market associated with the transaction data, the future stability of the or each market being a measure of predicted future market liquidity based on predetermined data patterns.

11. The system of claim 1, wherein the stored instructions further comprise instructions for controlling the processor to intervene in a transaction to encourage market stability.

12. The system of claim 11, wherein the instructions for controlling the processor to intervene comprise instructions for controlling the processor to intervene based on the determined stability and/or the predicted future stability of a market.

13. The system of claim 1, wherein the instructions for controlling the processor to intervene comprise instructions for controlling the processor to subsidize a transaction.

14. The system of claim 1, wherein the instructions for controlling the processor to intervene comprise instructions for controlling the processor to incentivize to the buyer and/or the seller.

15. The system of claim 11, wherein the instructions for controlling the processor to intervene comprise instructions for controlling the processor to intervene based on a financial intervention budget.

16. The system of claim 11, wherein the data store is further for storing historical transaction intervention data.

17. The system of claim 11, wherein the stored instructions further comprise instructions for controlling the processor to identify potential buyers and sellers for whose transactions are prioritized for intervention.

18. The system of claim 17, wherein the data store is further for storing buyer and seller identifiers of the identified buyers and sellers.

19. The system of claim 17, wherein the stored instructions further comprise instructions for contacting the identified buyers and sellers by email and or SMS message.

20. The system of claim 1, wherein instructions for implementing a seller interface and the instructions for implementing the buyer interface comprise instructions for communicating to sellers and buyers actions that will increase market stability.

21. The system of claim 1, wherein the stored instructions further comprise instructions for analyzing the effect of transaction intervention on market stability.

22. A method for managing the purchase of products and/or services by a buyer from sellers, the method comprising:
storing in a data store:
seller data comprising, for each of a plurality of sellers, a seller identifier and seller offer data indicating at least one product and/or service offered for sale; and
transaction data comprising, for each of a plurality of historical transactions, a transaction identifier, a seller identifier and a buyer identifier;
implementing a buyer interface to receive a purchase inquiry from a buyer, the purchase inquiry comprising purchase criteria for a product and/or service;
outputting seller offer data for a plurality of sellers, the sellers each being able to meet the purchase criteria for the product and/or service requirement;
receiving a purchase request from the buyer accepting an offer of the product and/or service from one of the sellers, thereby creating a transaction; and
analyzing the transaction data to determine stability of at least one market associated with the transaction data, the stability of the or each market being a measure of market liquidity.
